(19) United States
(12) Patent Application Publication
(10) Pub. No.: US 2024/0149642 A1
(43) Pub. Date: May 9, 2024

(54) VEHICLE AIR CONDITIONER

(71) Applicant: Hanon Systems, Daejeon (KR)

(72) Inventors: Gyu Ik HAN, Daejeon (KR); Jae Woo KO, Daejeon (KR); Ki Jung PARK, Daejeon (KR); Joon Yeong LEE, Daejeon (KR); Ki Man JEON, Daejeon (KR)

(21) Appl. No.: 18/279,363

(22) PCT Filed: Apr. 22, 2022
(86) PCT No.: PCT/KR2022/005781

§ 371 Date: Aug. 29, 2023

(30) Foreign Application Priority Data
Apr. 27, 2021 (KR) 10-2021-0054020
May 20, 2021 (KR) 10-2021-0064623

(51) Int. Cl. B60H 1/22; B60H 1/00

(52) U.S. Cl. CPC B60H 1/2225; B60H 1/00028; B60H 2001/00135; B60H 2001/2271

(57) ABSTRACT

A vehicle air conditioner for minimizing the leakage of air through a dual blocking structure between upper and lower flow paths, and having a dual blocking structure. An air-conditioning case having an inner air flow path is divided into an upper flow path and a lower flow path. A heat exchanger for cooling and a heat exchanger for heating are provided in the air flow path of the air-conditioning case. A member having through-holes is disposed downstream of the heat exchanger for heating in the flow direction of air and allows the air that has passed through the heat exchanger for heating to pass therethrough. The member having through-holes has a horizontal member dividing the upper flow path from the lower flow path. A leakage-preventing means is overlapped with the horizontal member so as to prevent the air in the upper flow path and the lower flow path from mixing.

### RELATED APPLICATIONS

This application is a U.S. National Stage of International Patent Application Serial No. PCT/KR2022/005781, filed Apr. 22, 2022, which claims the benefit of Korean Patent Application Serial No. 10-2021-0054020, filed Apr. 27, 2021, and Korean Patent Application Serial No. 10-2021-0064623, filed May 20, 2021. The entire disclosures of each of the above applications are incorporated herein by reference.

### FIELD

The present invention relates to an air conditioner for a vehicle, and more specifically, to an air conditioner for a vehicle, which includes a member having through-holes, having an electric heater, such as a PTC heater for heating air by electric power, or a dummy member.

### BACKGROUND

In general, an air conditioner for a vehicle is an apparatus for cooling or heating the interior of the vehicle by heating or cooling air. Such an air conditioner for a vehicle includes an evaporator, which is a heat exchanger for cooling, and a heater core, which is a heat exchanger for heating, inside an air-conditioning case, and selectively blows the air cooled by the evaporator or heated by the heater core toward parts of the interior of the vehicle.

Especially, in order to secure defogging performance and maintain a high-performance heating during heating, a two-layer air conditioner has been developed. In order to defrost windshields while driving with heat in winter, cold outdoor air with low humidity is effective, but it causes drop of indoor temperature.

The two-layer air conditioner substantializes a two-layer air flow of indoor air and outdoor air by supplying outdoor air to the upper part of the vehicle and by circulating indoor air to the lower part of the vehicle, so as to effectively defrost using fresh outdoor air with low humidity supplied to the upper part and to maintain high-performance heating by providing fresh outdoor air to passengers and providing warm indoor air to the lower part.

Referring to FIG. 1, a conventional two-layer air conditioner 1 for a vehicle includes an air-conditioning case 10. The air-conditioning case 10 has an air flow path of a predetermined shape formed therein, and the air flow path is divided into an upper flow path 14b and a lower flow path 14a by a separation wall 40. A plurality of air discharge ports are formed at an outlet side of the air-conditioning case 10. The air discharge ports are comprised of a defrost vent 16, a face vent 17, a front seat floor vent 18, and a rear seat floor vent 19.

A blower unit 5 is provided at an inlet side of the air-conditioning case 10, and an evaporator 2 and a heater core 20 are provided at a predetermined interval from each other in the air flow path of the air-conditioning case 10. Outdoor air is introduced and flows through the upper flow path 14b, and indoor air is introduced and flows into the lower flow path 14a. The upper flow path 14b is provided with a first temperature door 11 for adjusting the amount of air passing through the heater core 20 and the amount of air bypassing the heater core 20, and the lower flow path 14 a is provided with a second temperature door 12 for adjusting the amount of air passing through the heater core 20 and the amount of air bypassing the heater core 20.

The air discharge ports respectively include a defrost door 13a and a face door 13b for adjusting the amount of air discharged to the defrost vent 16 and the face vent 17. The air discharge ports further include a floor door 13c for adjusting the amount of air discharged to the front floor vent 18, a rear seat mode door 13d for adjusting the amount of air discharged to the rear seat floor vent 19, and a bypass door 13e for controlling the communication between the upper flow path 14b and the lower flow path 14a to allow the indoor air of the lower flow path 14a to flow to the upper flow path 14b.

Meanwhile, a PTC heater 30 may be provided at a downstream side of the heater core 20 in an air flow direction. The PTC heater 30 generates heat by application of electric power to heat air passing through the PTC heater 30, and serves as a heating heat source by assisting the heater core 20. The PTC heater 30 is provided or not provided in the air conditioner according to the specification of the vehicle. In the case of an air conditioner in which the PTC heater is not provided, a dummy PTC (Dummy PTC) is mounted in place of the PTC heater for common use of the air-conditioning case 10.

A conventional air conditioner for a vehicle includes a separator to divide the air-conditioning case into right and left sides in the width direction, and the separator has a through-hole for assembling the PTC heater or the dummy PTC. In this case, the through-hole may be formed to be slightly larger than the PTC heater or the dummy PTC and slightly larger than a horizontal separation wall for dividing the flow path into the upper flow path and the lower flow path to have a tolerance, thereby facilitating assembly of the PTC heater or the dummy PTC. Accordingly, the conventional air conditioner for a vehicle reduces air conditioning performance by generating a leak between the upper flow path and the lower flow path.

In addition, when the PTC heater is installed or not installed, the conventional air conditioner for a vehicle needs to improve a sealing structure at an installation position of the PTC heater in the air-conditioning case 10. If the sealing structure at the PTC heater installation position is weak, cold air may flow into the warm air flow path or warm air may flow into the cold air flow path due to the air leak to cause deterioration in air conditioning performance.

### SUMMARY

Accordingly, the present invention has been made in view of the above-mentioned problems occurring in the related art, and it is an object of the present invention to provide an air conditioner for a vehicle capable of minimizing an air leak through a dual blocking structure between upper and lower flow paths, and having an optimized dual blocking structure in consideration of assemblability.

In addition, in the case of a three-zone air conditioning device as well as a two-zone air conditioning device, the present invention provides an air conditioner for a vehicle, which can minimize the air leak by improving airtightness between an air-conditioning case and a dummy PTC.

### Technical Solution

To accomplish the above-mentioned objects, according to the present invention, there is provided an air conditioner for a vehicle which includes: an air-conditioning case having an indoor air flow path divided into an upper flow path and a lower flow path; and a heat exchanger for cooling and a heat exchanger for heating provided in the air flow path of the air-conditioning case, further including: a member having through-holes, which is disposed downstream of the heat exchanger for heating in an air flow direction and allows the air passing through the heat exchanger for heating to pass therethrough. The member having through-holes includes a horizontal member dividing the air flow path into an upper flow path and a lower flow path, and the air-conditioning case includes a leak prevention means overlapped with the horizontal member so as to prevent air mixing between the upper flow path and the lower flow path.

A separator is provided to divide the air flow path of the air-conditioning case in a width direction, and the leak prevention means is formed across the air flow path on the left and right air-conditioning cases and the separator.

The leak prevention means includes: a horizontal wall member extending below the horizontal member to be parallel to the horizontal member; and a vertical wall member bent upward from an end of the horizontal wall member.

The vertical wall member is higher than the horizontal member.

The horizontal member extends from the member having the through-holes toward the heat exchanger for heating, and is integrally provided with the member having the through-holes.

The separator includes assembly holes are perforated in the width direction so that the member having through-holes and the horizontal member pass through the assembly holes, and the leak prevention means extends from both sides of the separator in the width direction, and extends to overlap the assembly holes in the vertical direction and the back-and-forth direction.

The member having through-holes is a dummy PTC or a PTC heater generating heat by application of electric power.

An end of the vertical wall member is tapered to get narrower upward.

In another aspect of the present invention, there is provided an air conditioner for a vehicle, which includes: an air-conditioning case having an indoor air flow path divided into an upper flow path and a lower flow path; and a heat exchanger for cooling and a heat exchanger for heating provided in the air flow path of the air-conditioning case, and performs independent air-conditioning in different zones of the interior of the vehicle, further including: a member having through-holes, which is disposed downstream of the heat exchanger for cooling in an air flow direction and allows the air passing through the heat exchanger for cooling to pass therethrough, wherein the member having through-holes includes a plurality of ribs for filling a gap between the ribs and a separation wall of the air-conditioning case to prevent an air leak, and the plurality of ribs have different heights.

The rib has a horizontal separation wall dividing the air flow path up and down and a vertical separation wall dividing the air flow path from side to side, and the horizontal separation wall and the vertical separation wall of the member having through holes are different in height from each other.

The horizontal separation wall is higher than the vertical separation wall.

The air flow path of the air-conditioning case includes a front seat flow path for blowing air toward the front seat of the vehicle and a rear seat flow path for blowing air toward the rear seat, the member having through-holes has a front seat flow path rib for preventing a leak of the front seat flow path and a rear seat flow path rib for preventing a leak of the rear seat flow path, and the rear seat flow path rib is higher than the front seat flow path rib so that the rear seat flow path rib is positioned closer to the sealing surface of the air-conditioning case than the front seat flow path rib.

The indoor air flow path of the air-conditioning case is divided into an upper flow path and a lower flow path, the rear seat flow path is disposed at a central portion of the lower flow path in the width direction of the air-conditioning case, the front seat flow path is disposed at both sides of the rear seat flow path in the width direction, and the rear seat flow path rib is formed at the central portion in the width direction of the lower region to correspond to the rear seat flow path and extends along the boundary of the rear seat flow path.

The air conditioner for a vehicle, further includes a separator provided to divide the indoor air flow path of the air-conditioning case in a width direction, wherein the front seat flow paths are formed to vertically extend at a central portion in the width direction to correspond to the separator.

The rib is formed upstream of the member having through-holes in the air flow direction.

The rib extends integrally with one surface of the member having through-holes facing the heater core.

### Advantageous Effects

The air conditioner for a vehicle according to the present invention can reduce the total amount of a vertical leak of air by doubly blocking the air leak between the upper flow path 151 and the lower flow path due to the configuration of the leak prevention means, and can be easily manufactured by integrally injection-molding the leak prevention means when the separator is formed, and can be reduced in manufacturing cost.

In addition, the air conditioner for a vehicle according to the present invention can efficiently prevent warm air of the upper flow path passing through the heater core from leaking to the lower flow path, effectively prevent a leak between the upper flow path and the lower flow path generated through a fine gap of assembly holes since the leak prevention means is entirely formed in an L-shaped cross-sectional shape.

In addition, in a case in which the member having the through-holes is applied to both the type of performing two-zone independent air-conditioning control and the type of performing the three-zone independent air conditioning control with respect to the vehicle driver's seat and the front seat passenger seat, the air conditioner for a vehicle according to the present invention can perform stable and efficient sealing in different installation environments.

In addition, in a case in which the member having the through-holes is applied to the three-zone type air conditioner, the vertical separation wall may minimize the gap between the vertical separation wall and the separation wall of the air-conditioning case, thereby minimizing the leakage of the air of the front seat flow path to the rear seat flow path to prevent degradation of the air conditioning performance. In addition, the warm air passing through the heater core may be prevented from leaking toward the cold air flow path, and the air conditioning performance may be maintained in the best state by preventing the cold air bypassing the heater core from leaking toward the warm air flow path.

### BRIEF DESCRIPTION OF THE DRAWINGS

FIG. 1 is a side sectional view of a conventional air conditioner for a vehicle.

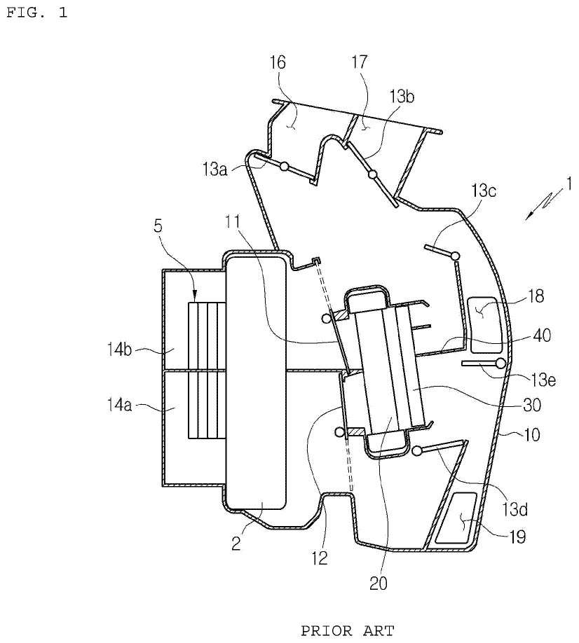

FIG. 2 is a side cross-sectional view of an air conditioner for a vehicle according to a first embodiment of the present invention.

FIG. 3 is an enlarged cross-sectional view of a portion of FIG. 2.

FIG. 4 is an enlarged side cross-sectional view of a leak prevention means according to the first embodiment of the present invention.

FIG. 5 is a perspective view illustrating a member having through-holes according to the first embodiment of the present invention.

FIG. 6 is a perspective view illustrating a separator and the leak prevention means according to the first embodiment of the present invention.

FIG. 7 is an exploded perspective view of the separator and the member having the through-holes according to the first embodiment of the present invention.

FIG. 8 is a side cross-sectional view of an air conditioner for a vehicle according to a second embodiment of the present invention.

FIG. 9 is an enlarged cross-sectional view of a portion of FIG. 8.

FIG. 10 is a perspective view illustrating a member having through-holes according to the second embodiment of the present invention.

FIG. 11 is a front view illustrating a member having through-holes according to a second embodiment of the present invention.

FIG. 12 is a sectional view taken along line A-A′ of FIG. 10.

FIG. 13 is a front sectional view illustrating an air flow path of an air-conditioning case according to the second embodiment of the present invention.

FIG. 14 is a perspective view illustrating a member having through-holes according to a third embodiment of the present invention.

### MODE FOR INVENTION

### Detailed Description

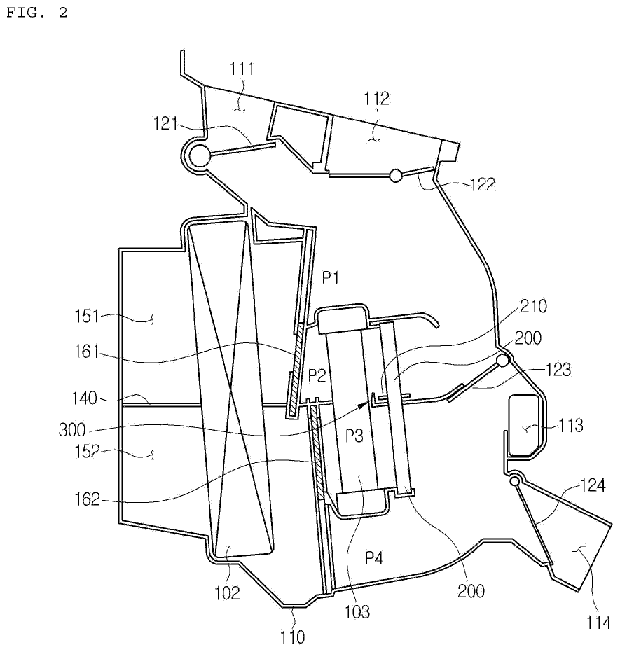

Hereinafter, a technical configuration of an air conditioner for a vehicle will be described in detail with reference to the accompanying drawings. In the following description, the left-right direction of FIG. 2 is the back-and-forth direction of an air-conditioning case, and the protrusion direction in the drawing is the width direction of the air-conditioning case.

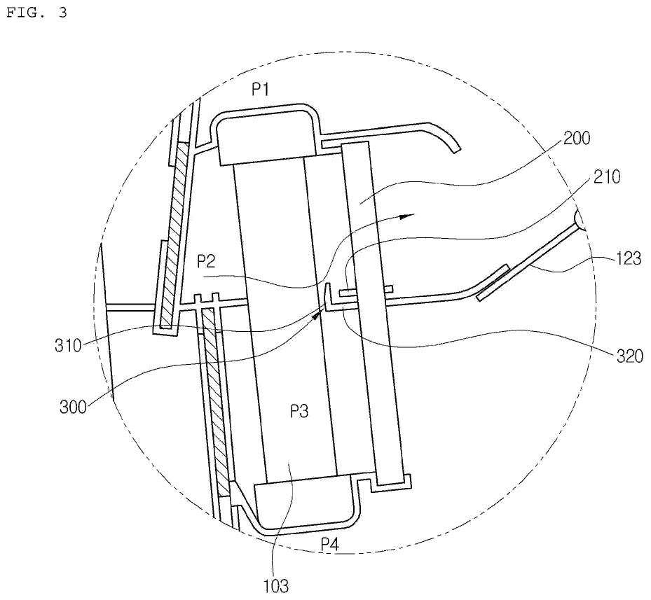

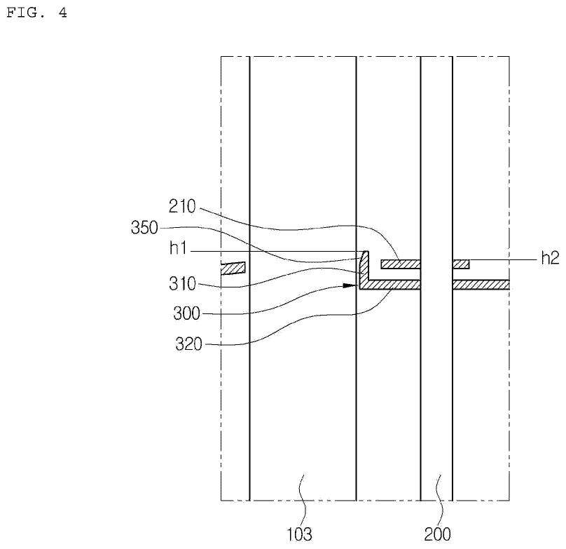

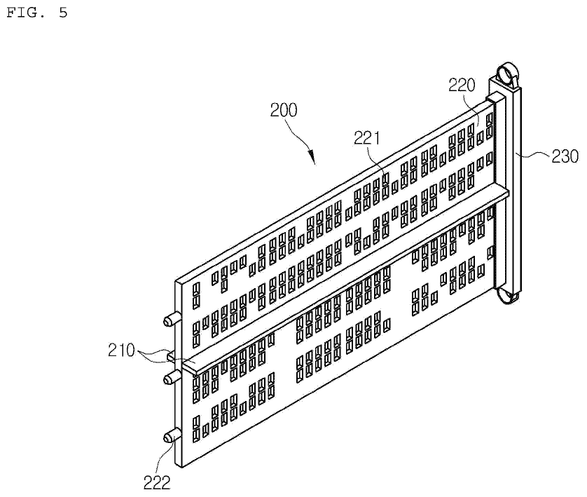

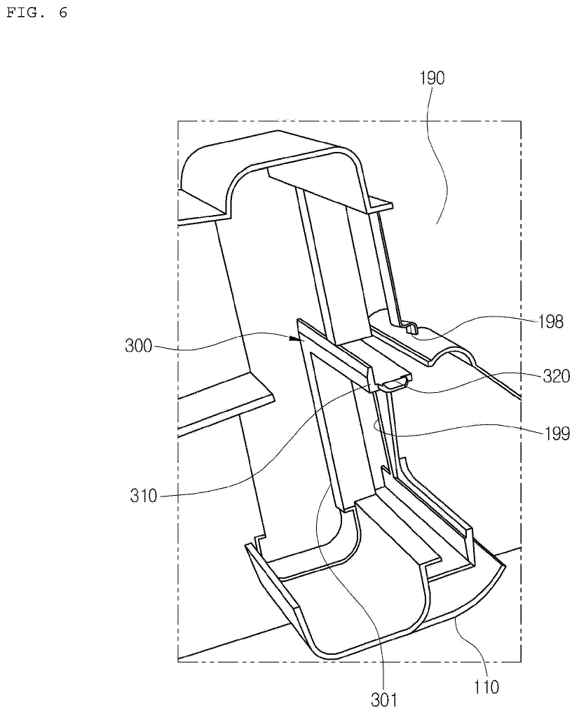

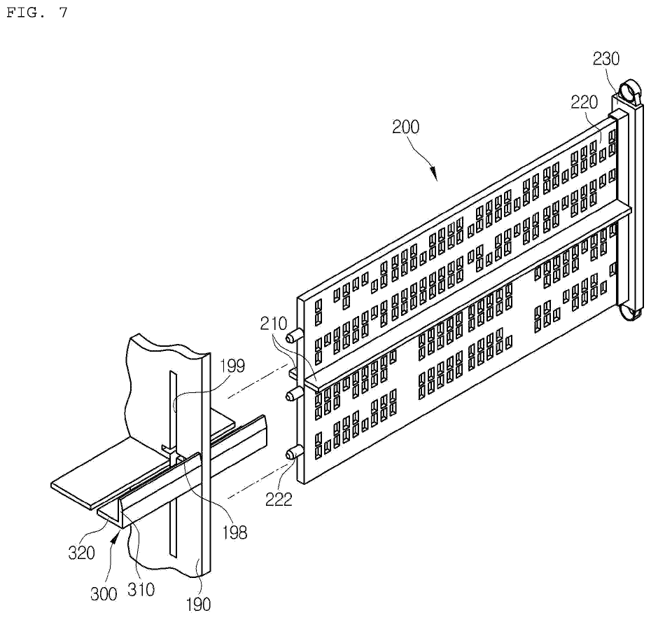

Referring to FIGS. 2 to 7, in order to improve defogging performance during heating, the air conditioner for a vehicle according to the first embodiment of the present invention is configured in the form of a two-layer structure that supplies outdoor air to an upper part thereof and circulates indoor air in a lower part thereof. The air conditioner for a vehicle includes an air-conditioning case 110, a plurality of doors, a blower unit, a heat exchanger for cooling and a heat exchanger for heating, and a member 200 having a through-hole.

The air-conditioning case 110 includes an air flow path formed therein, an air inflow port formed at an inlet thereof, and air discharge ports formed at an outlet thereof. The air discharge ports are comprised of a front seat air discharge port for discharging air to a front seat of the vehicle and a rear seat air discharge port for discharging air to a rear seat of the vehicle. In addition, the front seat air discharge port includes a defrost vent 111, a face vent 112, and a floor vent 113, and the rear seat air discharge port includes a console vent 114.

The plurality of doors are rotatably provided in the air-conditioning case 110 to adjust the opening degree of the air discharge ports. That is, the doors include a defrost door 121 for adjusting the opening degree of the defrost vent 111, a face door 122 for adjusting an opening degree of the face vent 112, a floor door 123 for adjusting the opening degree of the floor vent 113, and a console door 124 for adjusting the opening degree of the console vent 114.

The blower unit is provided at an air inflow port of the air-conditioning case 110, and is configured to selectively introduce indoor air and outdoor air. The inside of the blower unit is divided into an indoor air flow path through which indoor air flows and an outdoor air flow path through which outdoor air flows. The indoor air flowing in the indoor air flow path of the blower unit is blown to a lower flow path 152 of the air-conditioning case 110, and the outdoor air flowing through the outdoor air flow path of the blower unit is blown to an upper flow path 151 of the air-conditioning case 110.

The heat exchanger for cooling and the heat exchanger for heating are sequentially provided in the air flow path of the air-conditioning case 110 in an air flow direction. The heat exchanger for cooling includes an evaporator 102 configured to cool air by exchanging heat between refrigerant and air, and the heat exchanger for heating includes a heater core 103 configured to heat air by exchanging heat between cooling water and air. The heat exchanger for heating may be configured in the form of an indoor condenser using a heat pump system in addition to the heater core 103.

Meanwhile, the inside of the air-conditioning case 110 is divided into a plurality of air flow paths by a separation wall 140, that is, into the upper flow path 151 and the lower flow path 152. The air introduced into the indoor air flow path of the blower unit flows to the lower flow path 152 of the air-conditioning case 110, and the air introduced into the outdoor air flow path of the blower unit flows to the upper flow path 151 of the air-conditioning case 110. In addition, the air conditioner for a vehicle is configured to perform independent air conditioning in different areas of the interior of the vehicle. That is, three-zone independent air conditioning control of the driver's seat, the passenger seat, and the rear seat is possible.

Moreover, the two-layer air conditioner for a vehicle according to the present invention can maintain high heating performance while securing defogging performance during heating. That is, the two-layer air conditioner for a vehicle according to the present invention can supply outdoor air to the upper part of the vehicle and circulate indoor air in the lower part thereof, thereby effectively removing frost using fresh and low-humid outdoor air supplied to the upper part of the vehicle, providing fresh outdoor air to a passenger, maintaining high heating performance by suppling warm indoor air to the lower part.

An upper temperature door 161 is provided in the upper flow path 151, and a lower temperature door 162 is provided in the lower flow path 152. The upper temperature door 161 and the lower temperature door 162 are provided to be slidable between the evaporator 102 and the heater core 103 to adjust the amount of air passing through the heater core 103 and air bypassing the heater core according to a lifting action. The floor vent 113 is to discharge air toward the feet of the passenger, the console vent 114 is to discharge air to the rear seat of the vehicle, the defrost vent 111 is to discharge air toward the vehicle window, and the face vent 112 is to discharge air above the front seat of the vehicle.

The upper flow path 151 is divided into a warm air flow path P2 passing through the heater core 103, and a cold air flow path P1 disposed below the warm air flow path P2 and bypassing the heater core 103. In addition, the lower flow path 152 includes a front seat flow path for blowing air toward the front seat of the vehicle and a rear seat flow path for blowing air toward the rear seat. Furthermore, the lower flow path 152 is divided into a warm air flow path P3 passing through the heater core 103, and a cold air flow path P4 disposed below the warm air flow path P3 and bypassing the heater core 103.

That is, the cold air flow path P1 of the upper flow path 151, the warm air flow path P2 of the upper flow path 151, the warm air flow path P3 of the lower flow path 152, and the cold air flow path P4 of the lower flow path 152 are sequentially formed from the top to the bottom. More specifically, the cold air flow path P4 includes a rear seat cold air flow path and a front seat cold air flow path. The rear seat cold air flow path is disposed at a central portion in the width direction of the air-conditioning case 110 to blow air toward the front seat of the vehicle, and the front seat cold air flow path is disposed at both sides of the rear seat cold air flow path to blow air toward the rear seat of the vehicle. That is, the rear seat flow path is disposed at the central portion in the width direction, and the front seat flow path is disposed at both sides of the rear seat flow path.

The member 200 having the through-holes may include a dummy PTC or a PTC heater that generates heat by application of electric power. The PTC heater generates heat by application of electric power to heat air passing through the PTC heater. In the case of a vehicle without the PTC heater, the member 200 having the through-holes is the dummy PTC made of a synthetic resin or the like. Therefore, the air-conditioning case 110 may be commonly used in a vehicle without the PTC heater as well as a vehicle equipped with the PTC heater. In the first embodiment of the present invention, the member 200 having the through-holes is the dummy PTC.

The member 200 having the through-holes is arranged downstream of the heater core 103 in the air flow direction, and includes a main body 220 and a cover 230. The cover 230 is coupled to one side surface of the main body 220 in a state in which the main body 220 is inserted into the side surface of the air-conditioning case 110. A plurality of coupling protrusions 222 which are inserted into the coupling grooves of the air-conditioning case 110 are formed on the other side surface of the main body 220.

The main body 220 of the member 200 having through-hole has a plurality of through-holes 221 passing through the air-conditioning case 110 in the back-and-forth direction. The air passing through the heater core 103 passes through the through-holes 221. The member 200 having the through-holes includes a horizontal member 210. The horizontal member 210 extends in a direction perpendicular to the main body 220 of the member 200 having the through-holes, that is, in a horizontal direction, to divide the upper flow path 151 and the lower flow path 152.

Meanwhile, the air-conditioning case 110 includes a leak prevention means 300. The leak prevention means 300 is formed to overlap the horizontal member 210 formed in the member 200 having the through-holes, thereby preventing air mixing between the upper flow path 151 and the lower flow path 152. Due to the configuration of the leak prevention means 300, the air-conditioning case 110 can reduce the total amount of a vertical leak of air by doubly blocking the air leak between the upper flow path 151 and the lower flow path 152.

In addition, the air-conditioning case 110 includes a separator 190 at the central portion thereof in the width direction. The separator 190 extends in the vertical direction to divide the indoor air flow path of the air-conditioning case 110 from side to side in the width direction. The leak prevention means 300 is formed across the air flow path on the left and right air-conditioning cases 110 and the separator 190. In this case, the leak prevention means 300 is formed integrally with the separator 190 and the left and right air-conditioning cases 110. Through this configuration, the leak prevention means 300 may be integrally injection-molded when the separator 190 and the air-conditioning case 110 are formed, thereby facilitating manufacturing and reducing manufacturing costs.

More specifically, the leak prevention means 300 includes a horizontal wall member 320 and a vertical wall member 310. The horizontal wall member 320 extends below the horizontal member 210 of the member 200 having the through-holes to be parallel with the horizontal member 210. The vertical wall member 310 is bent upward from an end portion of the horizontal wall member 320, so the leak prevention means 300 is generally formed in an L-shaped cross-sectional shape. Through this configuration, it is possible to efficiently prevent warm air of the upper flow path 151 passing through the heater core 103 from leaking to the lower flow path 152.

A height h1 of the longitudinal wall member 310 is higher than a height h2 of the horizontal member 210. Through this configuration, the leak prevention means 300 doubly covers the horizontal member 210 in the front-rear direction and the vertical direction of the air-conditioning case 110. Meanwhile, it is preferable that a taper 350 is formed get narrower toward an upper portion of the vertical wall member 310. Meanwhile, the vertical wall member 310 is formed to face a heater core insertion hole 301. Due to the configuration of the taper 350, it is possible to minimize interference between the heater core 103 and the leak prevention means 300 facing the heater core 103 when the heater core 103 is inserted.

That is, the air in the upper flow path 151 passing through the heater core 103 tends to flow to the lower flow path 152 and receives a high wind pressure in the downward direction. The L-shaped leak prevention means 300 doubly covers a gap between the heater core 103 and the horizontal member 210, which cannot be covered by the horizontal member 210, in the back-and-forth direction and the vertical direction of the air-conditioning case 110, thereby efficiently blocking air of high pressure from flowing downward from the top.

The horizontal member 210 extends from the member 200 having the through-holes toward the heater core 103, and is formed integrally with the member 200 having the through-holes. In addition, assembly holes 198 and 199 are formed in the separator 190. The assembly holes 198 and 199 are formed to pass through the separator 190 in the width direction of the air-conditioning case 110, and pass through the member 200 having the through-holes and the horizontal member 210 during assembly. The longitudinally formed assembly hole 199 passes through the member 200 having the through-holes, and the horizontally formed assembly hole 198 passes through the horizontal member 210.

In this case, the assembly holes 198 and 199 are formed to be slightly larger than the member 200 having the through-holes and the horizontal member 210 to have a tolerance, thereby facilitating the assembly between the member 200 having the through-holes and the horizontal member 210. Accordingly, a leak occurs between the upper flow path 151 and the lower flow path 152 through the fine gap between the assembly holes 198 and 199, and thus the air-conditioning performance may be deteriorated. The leak prevention means 300 extends from both sides of the separator 190 in the width direction. In this case, the link preventing means 300 extends from the separator 190 to the inner walls of the left and right air-conditioning cases.

As a result, the leak prevention means 300 extends to overlap the assembly holes 198 and 199 in the vertical direction and the back-and-forth direction, thereby effectively preventing a leak between the upper flow path 151 and the lower flow path 152 through the fine gap of the assembly holes 198 and 199.

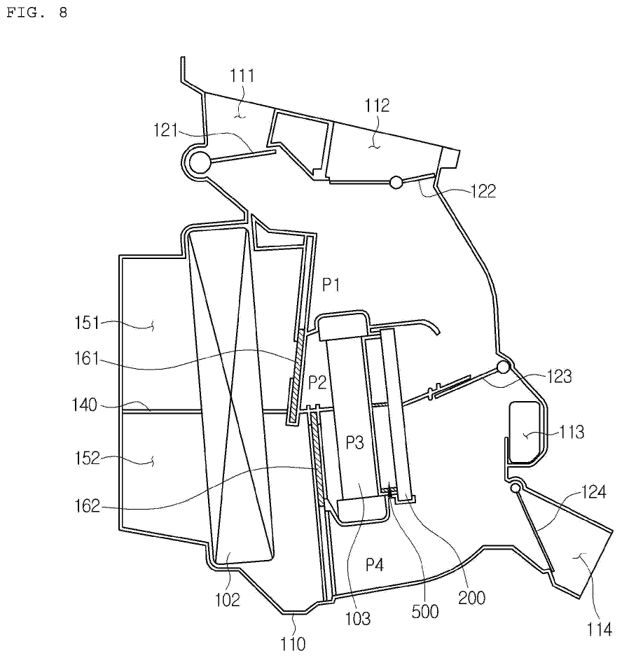

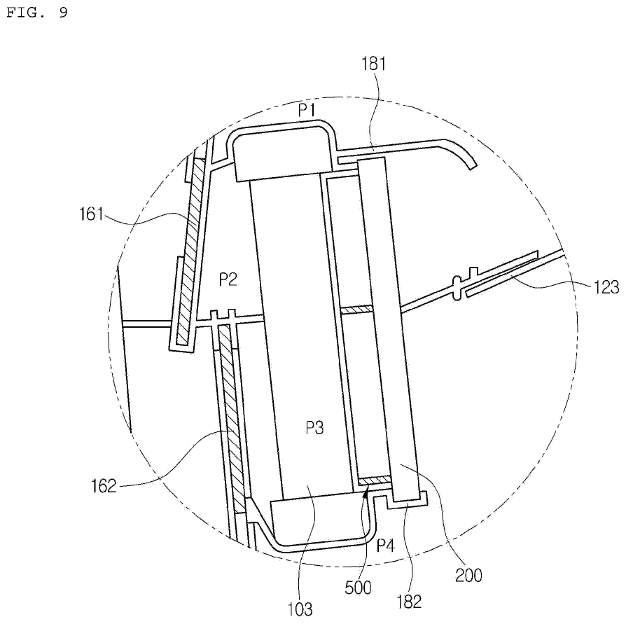

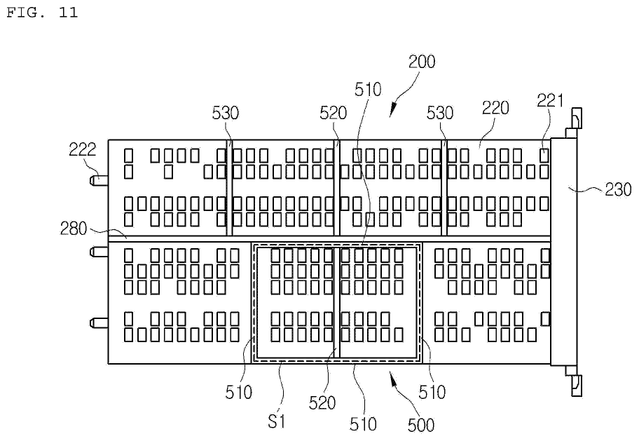

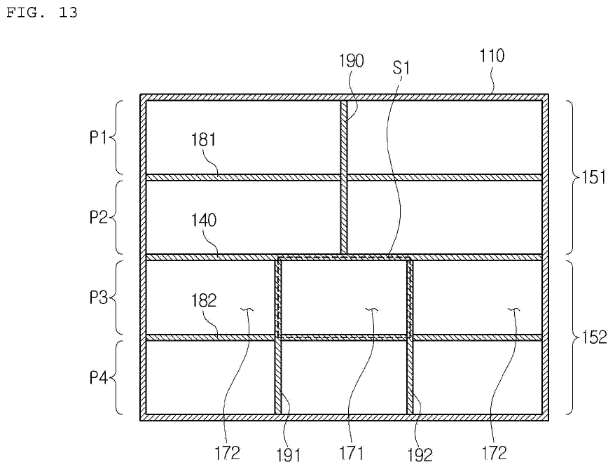

Meanwhile, referring to FIGS. 8 to 13, an air conditioner for a vehicle according to the second embodiment of the present invention is configured in the form of a two-layer structure that supplies outdoor air to an upper part thereof and circulates indoor air in a lower part thereof. The air conditioner for a vehicle includes an air-conditioning case 110, a plurality of doors, a blower unit, a heat exchanger for cooling and a heat exchanger for heating, and a member 200 having a through-hole.

The air-conditioning case 110 includes an air flow path formed therein, an air inflow port formed at an inlet thereof, and air discharge ports formed at an outlet thereof. The air discharge ports are comprised of a front seat air discharge port for discharging air to a front seat of the vehicle and a rear seat air discharge port for discharging air to a rear seat of the vehicle. In addition, the front seat air discharge port includes a defrost vent 111, a face vent 112, and a floor vent 113, and the rear seat air discharge port includes a console vent 114.

The plurality of doors are rotatably provided in the air-conditioning case 110 to adjust the opening degree of the air discharge ports. That is, the doors include a defrost door 121 for adjusting the opening degree of the defrost vent 111, a face door 122 for adjusting an opening degree of the face vent 112, a floor door 123 for adjusting the opening degree of the floor vent 113, and a console door 124 for adjusting the opening degree of the console vent 114.

The blower unit is provided at an air inflow port of the air-conditioning case 110, and is configured to selectively introduce indoor air and outdoor air. The inside of the blower unit is divided into an indoor air flow path through which indoor air flows and an outdoor air flow path through which outdoor air flows. The indoor air flowing in the indoor air flow path of the blower unit is blown to a lower flow path 152 of the air-conditioning case 110, and the outdoor air flowing through the outdoor air flow path of the blower unit is blown to an upper flow path 151 of the air-conditioning case 110.

The heat exchanger for cooling and the heat exchanger for heating are sequentially provided in the air flow path of the air-conditioning case 110 in an air flow direction. The heat exchanger for cooling includes an evaporator 102 configured to cool air by exchanging heat between refrigerant and air, and the heat exchanger for heating includes a heater core 103 configured to heat air by exchanging heat between cooling water and air. The heat exchanger for heating may be configured in the form of an indoor condenser using a heat pump system in addition to the heater core 103.

Meanwhile, the inside of the air-conditioning case 110 is divided into a plurality of air flow paths by a separation wall 140, that is, into the upper flow path 151 and the lower flow path 152. The air introduced into the indoor air flow path of the blower unit flows to the lower flow path 152 of the air-conditioning case 110, and the air introduced into the outdoor air flow path of the blower unit flows to the upper flow path 151 of the air-conditioning case 110. In addition, the air conditioner for a vehicle is configured to perform independent air conditioning in different areas of the interior of the vehicle. That is, three-zone independent air conditioning control of the driver's seat, the passenger seat, and the rear seat is possible.

An upper temperature door 161 is provided in the upper flow path 151, and a lower temperature door 162 is provided in the lower flow path 152. The upper temperature door 161 and the lower temperature door 162 are provided to be slidable between the evaporator 102 and the heater core 103 to adjust the amount of air passing through the heater core 103 and air bypassing the heater core according to a lifting action. The floor vent 113 is to discharge air toward the feet of the passenger, the console vent 114 is to discharge air to the rear seat of the vehicle, the defrost vent 111 is to discharge air toward the vehicle window, and the face vent 112 is to discharge air above the front seat of the vehicle.

The upper flow path 151 is divided into a warm air flow path P2 passing through the heater core 103 by an upper wall 181, and a cold air flow path P1 disposed below the warm air flow path P2 and bypassing the heater core 103. In addition, the lower flow path 152 includes a front seat flow path 172 for blowing air toward the front seat of the vehicle and a rear seat flow path 171 for blowing air toward the rear seat. Furthermore, the lower flow path 152 is divided into a warm air flow path P3 passing through the heater core 103 by a lower wall 182, and a cold air flow path P4 disposed below the warm air flow path P3 and bypassing the heater core 103. The upper wall 181 supports the upper end of the member 200 having the through-holes and the heater core 103, and the lower wall 182 supports the lower end of the member 200 having the through-holes and the heater core 103.

That is, the cold air flow path P1 of the upper flow path 151, the warm air flow path P2 of the upper flow path 151, the warm air flow path P3 of the lower flow path 152, and the cold air flow path P4 of the lower flow path 152 are sequentially formed from the top to the bottom. More specifically, the cold air flow path P4 includes a rear seat cold air flow path and a front seat cold air flow path. The rear seat cold air flow path is disposed at a central portion in the width direction of the air-conditioning case 110 to blow air toward the front seat of the vehicle, and the front seat cold air flow path is disposed at both sides of the rear seat cold air flow path to blow air toward the rear seat of the vehicle.

In addition, the air-conditioning case 110 is divided into a plurality of air flow paths in the width direction by separation walls. That is, the front seat flow path 172 and the rear seat flow path 171 on one side are partitioned by a first separation wall 191, and the front seat flow path 172 and the rear seat flow path 171 on the other side are partitioned by a second separation wall 192. The rear seat flow path 171 is disposed at the central portion in the width direction, and the front seat flow path 172 is disposed at both sides of the rear seat flow path 171. The member 200 having the through-holes may include a dummy PTC or a PTC heater that generates heat by application of electric power.

The member 200 having the through-holes is disposed downstream of the heat exchanger for cooling in the air flow direction. That is, the member 200 having the through-holes is disposed downstream of the heater core 103 and includes a main body 220 and a cover 230. The cover 230 is coupled to one side surface of the main body 220 in a state in which the main body 220 is inserted into the side surface of the air-conditioning case 110. A plurality of coupling protrusions 222 which are inserted into the coupling grooves of the air-conditioning case 110 are formed on the other side surface of the main body 220. Meanwhile, the air conditioner for a vehicle may not include the heater core 103 but only the member 200 having the through-holes, which includes the PTC heater.

The main body 220 of the member 200 having through-hole has a plurality of through-holes 221 passing through the air-conditioning case 110 in the back-and-forth direction. The member 200 having the through-holes includes a plurality of ribs 500. The ribs 500 fill a gap between the air-conditioning case 200 and the member 200 having the through-holes to prevent an air leak. In this case, the plurality of ribs 500 may have different heights.

As described above, as the plurality of ribs 500 have different heights, they perform a sealing function in different environments according to the heights. Therefore, in a case in which the member 200 having the through-holes is applied to both the type of performing two-zone independent air-conditioning control and the type of performing the three-zone independent air conditioning control with respect to the vehicle driver's seat and the front seat passenger seat, the ribs 500 may perform stable and efficient sealing in different installation environments.

The member 200 having the through-holes includes a front seat flow path rib 520 and a rear seat flow path rib 510. The front seat flow path rib 520 is to prevent a leak of the front seat flow path, and the rear seat flow path rib 510 is to prevent a leak of the rear seat flow path. In addition, the air-conditioning case 110 includes a separator 190 disposed at a central portion thereof in a width direction. The front seat flow path rib 520 vertically extends at the central portion in the width direction to correspond to the separator 190. The front seat flow path rib 520 is disposed at the central portion in the width direction to minimize leakage of the left air and right air through a gap with the heater core 103 in the width direction. The front seat flow path ribs 520 are respectively disposed in the upper flow path 151 and the lower flow path 152. In a case in which the front seat flow path ribs 520 are applied to a two-zone type air conditioner, the ribs 520 may perform a sealing function.

Meanwhile, the member 200 having the through-holes may further include a pair of reinforcing ribs 530. The reinforcing ribs 530 may be disposed at sides of the upper flow path 151, namely, a pair of the reinforcing ribs 530 may be provided at both sides of the front seat flow path rib 520 in the width direction. The reinforcing ribs 530 do not perform a sealing function, but may perform a function of reinforcing the strength of the member 200 having a through-hole formed in a relatively thin plate shape. In addition, a horizontal rib 280 for sealing with the separation wall 140 is provided at the central portion in the vertical direction of the member 200 having the through-holes.

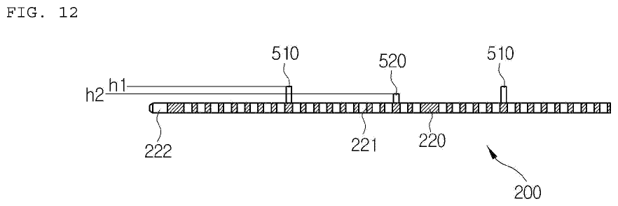

The rear seat flow path rib 510 is provided higher than that of the front seat flow path rib 520 so that the rear seat flow path rib 510 is positioned closer to the sealing surface of the air-conditioning case 110 than the front seat flow path rib 520. That is, as illustrated in FIG. 12, a protruding height h1 of the rear seat flow path rib 510 is formed higher than the protruding height h2 of the front seat flow path rib 520. Through this configuration, in a case in which the rear seat flow path rib 510 is applied to the three-zone type air conditioning device, the rear seat flow path rib 510 minimizes the gap between the rear seat flow path rib 510 and the air-conditioning case 110, thereby minimizing an air leak from the front seat flow path 172 to the rear seat flow path 171, thereby preventing the degradation of the air conditioning performance.

More specifically, the rear seat flow path rib 510 is formed at the central portion in the width direction of a lower region to correspond to the rear seat flow path 171, and extends along the boundary of the rear seat flow path 171. That is, an area S1 of the rear seat flow path 171 is formed in the central portion in the width direction of the lower flow path 152, and the rear seat flow path ribs 510 are formed at the upper, lower, left, and right sides so as to correspond to the boundary of the area S1 of the rear seat flow path 171. Accordingly, air leakage in four directions of the upper side, the lower side, the left side, and the right side may be prevented with respect to the rear seat flow path 171, thereby performing complete sealing.

The ribs 510 and 520 extend integrally with one surface of the member 200 having the through-holes facing the heater core 103. In particular, in a case in which the member 200 having the through-holes is the dummy PTC, the ribs 510 and 520 may be integrally injection-molded when the dummy PTC is formed, thereby facilitating manufacturing and reducing manufacturing costs.

In addition, the ribs 510 and 520 are formed upstream of the member 200 having the through-holes in the air flow direction. That is, the ribs 510 and 520 are formed between the heater core 103 and the member 200 having the through-holes, thereby preventing the warm air passing through the heater core 103 from leaking toward the cold air flow path and preventing cold air bypassing the heater core 103 from leaking toward the warm air flow path to maintain the air-conditioning performance in the best state.

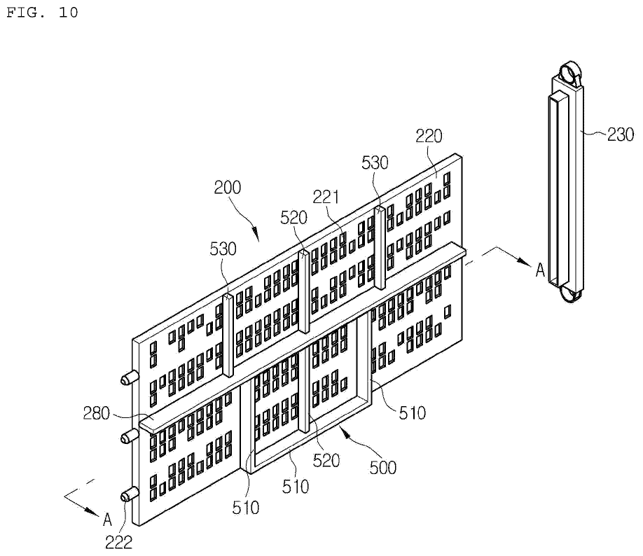

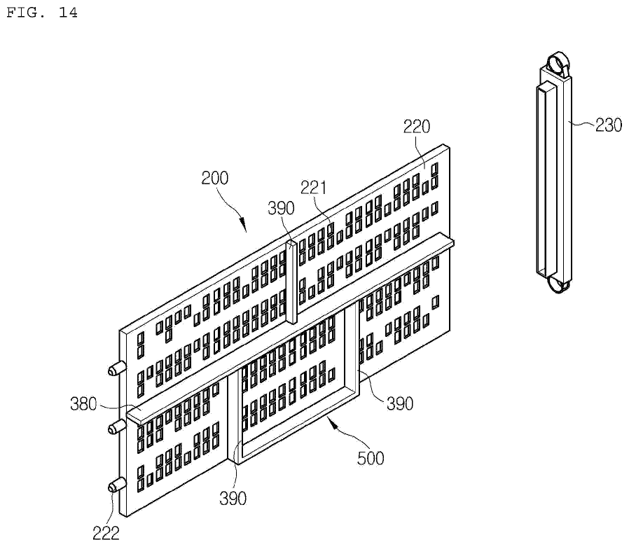

Meanwhile, FIG. 14 illustrates a modified example of FIG. 10. Referring to FIG. 14, the ribs 500 according to a third embodiment of the present invention may include a horizontal separation wall 580 dividing the air flow path up and down, and a vertical separation wall 590 dividing the air flow path from side to side. In this case, the height of the horizontal separation wall 580 and the height of the vertical separation wall 590 of the member 200 having the through-holes are different from each other. More specifically, the horizontal separation wall 580 is higher than the vertical separation wall 590.

Through this configuration, in a case in which the member 200 having the through-holes is applied to the three-zone type air conditioner, the vertical separation wall 590 may minimize the gap between the vertical separation wall 590 and the separation wall of the air-conditioning case 110, thereby minimizing the leakage of the air of the front seat flow path 172 to the rear seat flow path 171 to prevent degradation of the air conditioning performance.

1. An air conditioner for a vehicle, which includes: an air-conditioning case having an indoor air flow path divided into an upper flow path and a lower flow path; and a heat exchanger for cooling and a heat exchanger for heating provided in the air flow path of the air-conditioning case, comprising:
a member having through-holes, which is disposed downstream of the heat exchanger for heating in an air flow direction and allows the air passing through the heat exchanger for heating to pass therethrough,
wherein the member having through-holes includes a horizontal member dividing the air flow path into an upper flow path and a lower flow path, and
wherein the air-conditioning case includes a leak prevention means overlapped with the horizontal member so as to prevent air mixing between the upper flow path and the lower flow path.

2. The air conditioner according to claim 1, wherein a separator is provided to divide the air flow path of the air-conditioning case in a width direction, and
wherein the leak prevention means is formed across the air flow path on the left and right air-conditioning cases and the separator.

3. The air conditioner according to claim 1, wherein the leak prevention means includes: a horizontal wall member extending below the horizontal member to be parallel to the horizontal member; and a vertical wall member bent upward from an end of the horizontal wall member.

4. The air conditioner according to claim 3, wherein the vertical wall member is higher than the horizontal member.

5. The air conditioner according to claim 1, wherein the horizontal member extends from the member having the through-holes toward the heat exchanger for heating, and is integrally provided with the member having the through-holes.

6. The air conditioner according to claim 2, wherein the separator includes assembly holes are perforated in the width direction so that the member having through-holes and the horizontal member pass through the assembly holes, and
wherein the leak prevention means extends from both sides of the separator in the width direction, and extends to overlap the assembly holes in the vertical direction and the back-and-forth direction.

7. The air conditioner according to claim 1, wherein the member having through-holes is a dummy PTC or a PTC heater generating heat by application of electric power.

8. The air conditioner according to claim 3, wherein an end of the vertical wall member is tapered to get narrower upward.

9. An air conditioner for a vehicle, which includes: an air-conditioning case having an indoor air flow path divided into an upper flow path and a lower flow path; and a heat exchanger for cooling and a heat exchanger for heating provided in the air flow path of the air-conditioning case, and performs independent air-conditioning in different zones of the interior of the vehicle, comprising:
a member having through-holes, which is disposed downstream of the heat exchanger for cooling in an air flow direction and allows the air passing through the heat exchanger for cooling to pass therethrough,
wherein the member having through-holes includes a plurality of ribs for filling a gap between the ribs and a separation wall of the air-conditioning case to prevent an air leak, and the plurality of ribs have different heights.

10. The air conditioner according to claim 9, wherein the rib has a horizontal separation wall dividing the air flow path up and down and a vertical separation wall dividing the air flow path from side to side, and
wherein the horizontal separation wall and the vertical separation wall of the member having through holes are different in height from each other.

11. The air conditioner according to claim 10, wherein the horizontal separation wall is higher than the vertical separation wall.

12. The air conditioner according to claim 9, wherein the air flow path of the air-conditioning case includes a front seat flow path for blowing air toward the front seat of the vehicle and a rear seat flow path for blowing air toward the rear seat,
wherein the member having through-holes has a front seat flow path rib for preventing a leak of the front seat flow path and a rear seat flow path rib for preventing a leak of the rear seat flow path, and
wherein the rear seat flow path rib is higher than the front seat flow path rib so that the rear seat flow path rib is positioned closer to the sealing surface of the air-conditioning case than the front seat flow path rib.

13. The air conditioner according to claim 12, wherein the indoor air flow path of the air-conditioning case is divided into an upper flow path and a lower flow path, the rear seat flow path is disposed at a central portion of the lower flow path in the width direction of the air-conditioning case, the front seat flow path is disposed at both sides of the rear seat flow path in the width direction, and the rear seat flow path rib is formed at the central portion in the width direction of the lower region to correspond to the rear seat flow path and extends along the boundary of the rear seat flow path.

14. The air conditioner according to claim 12, further comprising:
a separator provided to divide the indoor air flow path of the air-conditioning case in a width direction,
wherein the front seat flow paths are formed to vertically extend at a central portion in the width direction to correspond to the separator.

15. The air conditioner according to claim 9, wherein the rib is formed upstream of the member having through-holes in the air flow direction.

16. The air conditioner according to claim 9, wherein the rib extends integrally with one surface of the member having through-holes facing the heater core.
